(19) United States
(12) Patent Application Publication
(10) Pub. No.: US 2018/0326519 A1
(43) Pub. Date: Nov. 15, 2018

(54) SAW WIRE AND CUTTING APPARATUS

(71) Applicant: PANASONIC INTELLECTUAL PROPERTY MANAGEMENT CO., LTD., Osaka (JP)

(72) Inventors: Tomohiro KANAZAWA, Osaka (JP); Masato WADA, Hyogo (JP); Takayuki IMAI, Osaka (JP); Tetsuji SHIBATA, Osaka (JP); Kazushige SUGITA, Hyogo (JP); Naoki KOHYAMA, Osaka (JP); Hiroshi GOUDA, Osaka (JP); Yoshitaka MIZUGUCHI, Osaka (JP)

(73) Assignee: PANASONIC INTELLECTUAL PROPERTY MANAGEMENT CO., LTD., Osaka (JP)

(21) Appl. No.: 15/975,183

(22) Filed: May 9, 2018

(30) Foreign Application Priority Data
May 10, 2017 (JP) 2017-094243

(51) Int. Cl. B23D 61/18; B21C 1/00

(52) U.S. Cl. CPC B23D 61/185; C22C 27/04; B21C 1/003

(57) ABSTRACT

A saw wire and various methods of use and manufacture are provided. The saw wire includes a metal wire containing at least one of tungsten and a tungsten alloy. A surface roughness Ra of the metal wire is at most 0.15 μm. A tensile strength of the metal wire is at least 3500 MPa. A diameter of the metal wire is at most 60 μm.

### CROSS REFERENCE TO RELATED APPLICATION

This application claims the benefit of priority of Japanese. Patent Application Number 2017-094243 filed on May 10, 2017, the entire content of which is hereby incorporated by reference.

### BACKGROUND

### 1. Technical Field

The present disclosure relates to a saw wire and a cutting apparatus including the saw wire.

### 2. Description of the Related Art

Conventionally, a multi-wire saw for slicing a silicon ingot using wires composed of piano wire, has been known (see reference, for example, to Japanese Unexamined Patent Application Publication No. 2008-213111).

### SUMMARY

During the slicing operation of a wire saw, swarf is produced in an amount approximately corresponding to the wire diameter. The aforementioned multi-wire saw uses wires composed of piano wire, however, it is difficult to reduce the diameter size of piano wire. It is thus difficult, in the present conditions, to manufacture piano wire having a diameter less than 60 μm. In addition, since piano wire has an elastic modulus of at least 150 GPa and at most 250 GPa, even if the piano wire could be thinned, deflection still occurs during the slicing process. Therefore, thinned piano wire is unsuitable for use in wire-saw slicing.

In view of the above, an object of the present disclosure is to provide a saw wire capable of reducing kerf loss of an object to be cut, and a cutting apparatus including the saw wire.

In order to achieve the above-described object, a saw wire according to an aspect of the present disclosure includes a metal wire containing at least one of tungsten and a tungsten alloy. A surface roughness Ra of the metal wire is at most 0.15 μm, a tensile strength of the metal wire is at least 3500 MPa, and a diameter of the metal wire is at most 60 μm.

In addition, a cutting apparatus according to an aspect of the present disclosure includes the saw wire.

In addition, a method of slicing an ingot according to an aspect of the present disclosure is a method including: moving at least one saw wire relative to the ingot, each saw wire including a metal wire containing at least one of tungsten and a tungsten alloy, a surface roughness Ra of the metal wire being at most 0.15 μm, a tensile strength of the metal wire being at least 3500 MPa, and a diameter of the metal wire being at most 60 μm; and dividing the ingot at least into partly-sliced portions by the at least one saw wire.

In addition, a method of manufacturing a saw wire according to an aspect of the present disclosure is a method including; forming a metal wire containing at least one of tungsten and a tungsten alloy, in which a surface roughness Ra of the metal wire is at most 0.15 μm, a tensile strength of the metal wire is at least 3500 MPa, and a diameter of the metal wire is at most 60 μm.

According to the present disclosure, it is possible to provide a saw wire capable of reducing kerf loss of an object to be cut, and a cutting apparatus including the saw wire.

### BRIEF DESCRIPTION OF DRAWINGS

The figures depict one or more implementations in accordance with the present teaching, by way of examples only, not by way of limitations. In the figures, like reference numerals refer to the same or similar elements.

FIG. 1 is a perspective diagram which illustrates a cutting apparatus according to an embodiment;

FIG. 2 is a cross-sectional view which illustrates how an ingot is sliced by the cutting apparatus according to the embodiment; and

FIG. 3 is a transition diagram which illustrates a manufacturing method of a saw wire according to the embodiment.

### DETAILED DESCRIPTION OF THE EMBODIMENTS

The following describes in detail a saw wire and a cutting apparatus according to an embodiment of the present disclosure, with reference to the drawings. It should be noted that the embodiment described below indicates one specific example of the present disclosure. The numerical values, shapes, materials, structural components, the disposition and connection of the structural components, etc. described in the following embodiment are mere examples, and do not intend to limit the present disclosure. Furthermore, among the structural components in the following exemplary embodiment, components not recited in the independent claim which indicates the broadest concept of the present invention are described as arbitrary structural components.

In addition, each diagram is a schematic diagram and not necessarily strictly illustrated. Accordingly, for example, scale sizes, etc., are not necessarily exactly represented. In each of the diagrams, substantially the same structural components are assigned with the same reference signs, and redundant descriptions will be omitted or simplified.

In addition, a term, such as “parallel” or “equal”, representing a relationship between the components as well as a term, such as “circular”, representing a form, and a numerical range are used in the present description. Such terms and range are each not representing only a strict meaning of the term or range, but implying that a substantially same range, e.g., a range that includes even a difference as small as a few percentage points, is connoted in the term or range.

### Embodiment

(Cutting Apparatus)

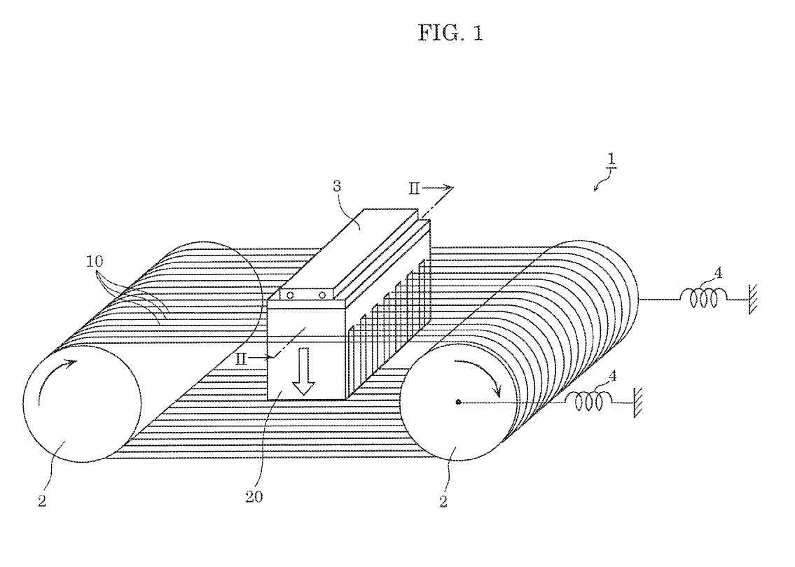

First, an overview of a cutting apparatus including a saw wire according to the present embodiment will be described with reference to FIG. 1. FIG. 1 is a perspective view which illustrates cutting apparatus 1 according to the present embodiment.

As illustrated in FIG. 1, cutting apparatus 1 is a multi-wire saw including saw wire 10. Cutting apparatus 1 produces wafers by, for example, cutting ingot 20 into thin slices. Ingot 20 is, for instance, a silicon ingot including single-crystal silicon. More specifically, cutting apparatus 1 simultaneously produces silicon wafers by slicing ingot 20 using saw wire 10.

It should be noted that ingot 20 is a silicon ingot but is not limited to such. For example, an ingot including other substance such as silicon carbide or sapphire may be used. Alternatively, an object to be cut by cutting apparatus 1 may be concrete, glass, etc.

As illustrated in FIG. 1, cutting apparatus 1 further includes two guide rollers 2, ingot holder 3, and tension releasing device 4.

A single saw wire 10 is looped multiple times over two guide rollers 2. Here, for convenience of explanation, one loop of saw wire 10 is regarded as one saw wire 10, and it is assumed that a plurality of saw wires 10 are looped over two guide rollers 2. Stated differently, in the description below, the plurality of saw wires 10 form a single continuous saw wire 10. It should be noted that the plurality of saw wires 10 may be a plurality of saw wires that are separated from one another.

Each of guide rollers 2 rotates in the state in which saw wire 10 is straightly tightened with a predetermined tension, and thereby causes saw wire 10 to rotate at a predetermined speed. Saw wires 10 are disposed in parallel to one another and are equally spaced. More specifically, each guide roller 2 is provided with grooves positioned at predetermined intervals for saw wires 10 to fit in. The intervals between the grooves are determined according to the thickness of the wafers desired to be sliced off. The width of the groove is substantially the same as diameter φ of saw wire 10.

Tension releasing device 4 is a device that releases tension exerted on saw wire 10. Tension releasing device 4 is, far example, an elastic body such as a coiled or plate spring. As illustrated in FIG. 1, tension releasing device 4 that is a coiled spring, for example, has one end connected to guide roller 2 and the other end fixed to a predetermined wall surface. Tension releasing device 4 is capable of releasing the tension exerted on saw wire 10, by adjusting the position of guide roller 2.

It should be noted that cutting apparatus 1 may include three or more guide rollers 2. Saw wires 10 may be looped over three or more guide rollers 2.

Ingot holder 3 holds ingot 20 which is an object to be cut. Ingot holder 3 pushes ingot 20 through saw wires 10, and thereby ingot 20 is sliced by saw wires 10.

It should be noted that, although not illustrated in the diagram, cutting apparatus 1 may be a cutting apparatus of a free abrasive particle type, and may include a feeder that feeds slurry to a plurality of saw wires 10. The slurry is a cutting fluid, such as a coolant including abrasive particles dispersed therein. The abrasive particles included in the slurry are fixed to saw wire 10, and thereby it is possible to easily cut ingot 20. Examples of the abrasive particles include diamond, cubic boron nitride (CBN), etc.

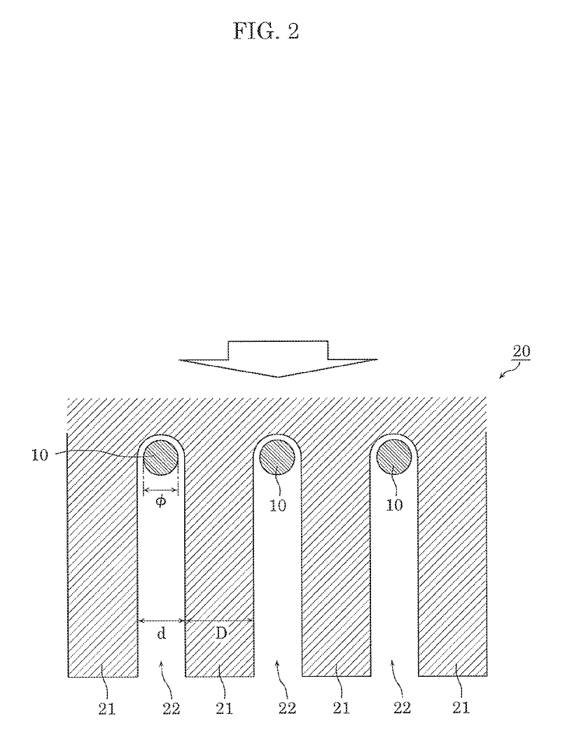

FIG. 2 is a cross-sectional view which illustrates how ingot 20 is sliced by cutting apparatus 1 according to the present embodiment. FIG. 2 illustrates a cross section that is taken along the line II-II illustrated in FIG. 1 and that is orthogonal to the extending direction of saw wire 10. More specifically, FIG. 2 illustrates how three saw wires 10 among saw wires 10 slice ingot 20.

By pushing ingot 20 through saw wires 10, ingot 20 is simultaneously divided into partly-sliced portions 21 by saw wires 10. Space 22 between neighboring partly-sliced portions 21 is a space made by ingot 20 being scraped off by saw wire 10. In other words, the size of space 22 is equivalent to a kerf loss of ingot 20.

Width d of space 22 depends on diameter φ of saw wire 10. Stated differently, width d increases as diameter φ of saw wire 10 becomes larger, and thereby, the kerf loss of ingot 20 increases. Width d decreases as diameter φ of saw wire 10 becomes smaller, and thereby, the kerf loss of ingot 20 decreases.

More specifically, width d of space 22 becomes greater than diameter φ. The difference between width d and diameter φ depends on the size of abrasive particles fixed to saw wire 10 and the oscillation width of the vibrations caused when saw wire 10 rotates around guide rollers 2. Here, the oscillation width of saw wire 10 can be reduced by tightly tensioning saw wire 10. The higher the tensile strength and elastic modulus of saw wire 10 become, it becomes possible to more tightly tension saw wire 10. Thus, the oscillation width of saw wire 10 is reduced and thereby width d of space 22 can be reduced. As a result, it is possible to further reduce the kerf loss of ingot 20.

It should be noted that thickness D of partly-sliced portion 21 depends on the intervals at which saw wires 10 are disposed. Accordingly, wire saws 10 are disposed at intervals each resulting from adding desired thickness D and a predetermined margin. More specifically, a margin is a difference between width d and diameter φ, and is a value determined in accordance with the oscillation width of saw wire 10 and the grain diameter of the abrasive particle.

Based on what has been described above, diameter φ, the tensile strength, and the elastic modulus of saw wire 10 are significant parameters in order to reduce the kerf loss of ingot 20. More specifically, by decreasing diameter φ of saw wire 10 or increasing the tensile strength and elastic modulus of saw wire 10, the kerf loss of ingot 20 can be reduced.

The stress applied to ingot 20 is more uniformed, with a decrease in the surface roughness Ra of saw wire 10. Accordingly, it is possible to cut ingot 20 smoothly. Thus, when the surface roughness Ra is small, the oscillation width of saw wire 10 can be reduced as well. Accordingly, it is possible to reduce the kerf loss of ingot 20.

The following describes the structure and manufacturing method of saw wire 10.

(Saw Wire)

Saw wire 10 according to the present embodiment includes a metal wire containing rhenium-tungsten (ReW) alloy. According to the present embodiment, saw wire 10 is quite simply a metal wire.

Saw wire 10 contains tungsten as a major component, and a predetermined proportion of rhenium. The rhenium content of saw wire 10 is, for example, at least 0.1 wt % and at most 10 wt % with respect to a total weight of rhenium and tungsten. For example, the rhenium content may be at least 0.5 wt % and at most 5 wt %. Although the rhenium content is 3 wt % as one example, it may be 1 wt %. The tensile strength of saw wire 10 increases with an increase in the rhenium content. However, when the rhenium content is excessively high, it becomes difficult to render saw wire 10 thinner.

The metal wire containing the ReW alloy has a strength per an area of cross-section that increases with a decrease in diameter. Accordingly, use of the metal wire containing the ReW alloy makes it possible to implement saw wire 10 which has small diameter φ and is high in tensile strength and elastic modulus, and to reduce a kerf loss of ingot 20.

Specifically, the tensile strength of saw wire 10 is at least 3500 MPa. The tensile strength of saw wire 10 is, for example, at least 3500 MPa and at most 6000 MPa, but is not limited to this example. The tensile strength of saw wire may be, for example, at least 400 MPa and at most 5000 MPa.

In addition, the elastic modulus of saw wire 10 is at least 350 GPa and at most 450 GPa. It should be noted that the elastic modulus is longitudinal elastic modulus. In other words, saw wire 10 has an elastic modulus approximately twice as high as that of piano wire.

Diameter φ of saw wire 10 is at most 60 μm. For example, diameter φ Although diameter φ of saw wire 10, specifically, is 20 μm, it may be 10 μm. Saw wire 10 is formed to be uniform in diameter φ. Note that diameter φ of saw wire 10 may not be entirely uniform and the size of diameter φ may slightly differ by approximately a few percentage points, e.g., 1%, depending on. the portion of saw wire 10. Since the diameter of saw wire 10 is at most 60 μm, saw wire 10 has elasticity and thus can be bent easily to a satisfactory extent. Accordingly, it is possible to easily loop saw wire 10 over and across guide rollers 2.

It should be noted that saw wire 10 may also be used in a cutting apparatus of a fixed abrasive particle type. For example, abrasive particles such as diamond particles may be fixed to the surface. In this case, when diameter φ of saw wire 10 is excessively small, there is a possibility that the abrasive particles are prone to be detached. Accordingly, diameter φ of saw wire 10, for example, may be greater than or equal to 10 μm.

Saw wire 10 is, for example, a metal wire which has a circular shape in the cross-section orthogonal to the extending direction of the wire, but not limited to this example. The cross-section shape of saw wire 10 may be rectangular such as square, oval, or other shape.

The surface roughness Ra of saw wire 10 is at most 0.15 μm. It should be noted that the surface roughness Ra may be less than or equal to 0.10 μm. When abrasive particles are fixed to the surface of saw wire 10, it is possible to enhance the attachment of the abrasive particle by forming a plating layer. In this case, when the surface roughness Ra is excessively small, the adhesion of the plating layer decreases, and thus the surface roughness Ra of saw wire 10 may be greater than 0.05 μm, for example.

(Manufacturing Method of Saw Wire)

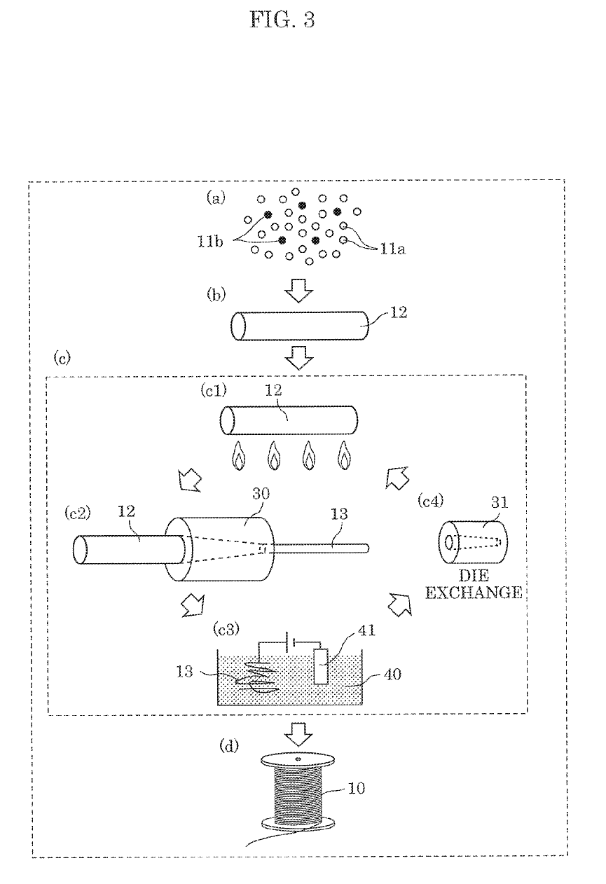

The following describes a manufacturing method of saw wire 10 having the above-described features, with reference to FIG. 3. FIG. 3 is a transition diagram which illustrates a manufacturing method of saw wire 10 according to the present embodiment.

First, predetermined proportions of tungsten powder 11a and rhenium powder 11b are prepared, as illustrated in (a) in FIG. 3. More specifically, rhenium powder 11b is prepared in the range from 0.1% to 10% of the total weight of tungsten powder 11a and rhenium powder 11b and the rest is defined to be tungsten powder 11a. Average grain diameter of tungsten powder 11a and rhenium powder 11b, respectively, is 5 μm, for example, but is not, limited to this example.

Next, by pressing and sintering a mixture of tungsten powder 11a and rhenium powder 11b, a ReW ingot containing rhenium-tungsten alloy is produced. By performing, onto the ReW ingot, a swaging processing of extending an ingot by press-forging the ingot from its periphery, wire-like ReW filament 12 is produced, as illustrated in (b) in FIG. 3. For example, wire-like ReW filament 12 has a diameter of approximately 3 mm whereas the ReW ingot being a sintered body has a diameter of approximately 15 mm.

Next, drawing processing using wire drawing dies is carried out, as illustrated in (c) in FIG. 3.

To be specific, firstly, ReW filament 12 is annealed, as illustrated in (c1) in FIG. 3. More precisely, ReW filament 12 is heated not only directly with a burner, but, is heated also by applying electrical current to ReW filament 12. The annealing process is performed in order to eliminate processing distortion generated in the swaging or drawing processing.

Next, drawing of ReW filament 12 using wire drawing die 30, i.e., a wire drawing process, is performed, as illustrated in (c2) in FIG. 3. It should be noted that since ReW filament 12 is rendered ductile after having been heated in the previous step of annealing process, wire drawing can be easily carried out. By reducing the diameter size of ReW filament 12, the strength of ReW filament 12 per an area of cross-section becomes higher. In other words, ReW filament 13 whose diameter size is reduced in the wire drawing process has a tensile strength per an area of cross-section higher than that of ReW filament 12. It should be noted that the diameter of ReW filament 13 is, for example, 0.6 mm, but is not limited to this example.

Next, through the electrolytic polishing of ReW filament 13 after the drawing process, the surface of ReW filament 13 is rendered smooth, as illustrated. In (c3) in FIG. 3. The electrolytic polishing process is carried out by conducting electricity between ReW filament 13 and counter electrode 41 such as a carbon rod, in the state in which ReW filament 13 and counter electrode 41 are bathed into electrolyte 40, e.g., aqueous sodium hydroxide.

Next, die exchange is performed, as illustrated in (c4) in FIG. 3. More specifically, wire drawing die 31 with a pore diameter smaller than that of wire drawing die 30 is selected as a die to be used in the next drawing processing. It should be noted that wire drawing dies 30 and 31 are, for example, diamond dies containing sintered diamond, single-crystal diamond, or the like.

The processes from (c1) to (c4) illustrated in FIG. 3 are repeatedly performed until the diameter of ReW filament 13 is thinned down to a desired diameter (specifically, less than or equal to 60 μm). At this time, the drawing process illustrated in (c2) in FIG. 3 is performed by adjusting the form as well as hardness of wire drawing die 30 or 31, a lubricant to be used, and the temperature of a ReW filament, in accordance with the diameter of the ReW filament to be processed.

Similarly, in the annealing process illustrated in (c1) in FIG. 3, annealing conditions are adjusted in accordance with the diameter of the ReW filament to be processed. Through the annealing process, an oxidation product is attached to the surface of the ReW filament. It is possible to adjust the amount of oxidation products to he attached to the surface of the ReW filament, by adjusting the annealing conditions.

More specifically, the larger the diameter of the ReW filament is, at higher temperature the ReW filament is annealed, and the smaller the diameter of the ReW filament is, at lower temperature the ReW filament is annealed. To be more concrete, in the case where the diameter of the ReW filament is large, for example, the ReW filament is annealed at the temperature between 1400 degrees Celsius and 1800 degrees Celsius in the annealing process carried out in the first drawing processing. In the final annealing process carried out in the final drawing processing in which the ReW filament is thinned down to finally have a desired diameter, the ReW filament is heated at the temperature between 1200 degrees Celsius and 1500 degrees Celsius. It should be noted that, in the final annealing process, electricity need not be conducted to the ReW filament.

Moreover, an annealing process may be omitted when a drawing processing is repeated. For example, the final annealing process may be omitted. More specifically, the final annealing process may be omitted and a lubricant as well as the form and hardness of a wire drawing die may be adjusted.

In the drawing process after the final annealing process (i.e., the final drawing process), a single-crystal diamond die containing single-crystal diamond is used as wire drawing die 31. Diamond particles are less likely to be detached in the process using the single-crystal diamond die, and thus a streak is less likely to be formed on the ReW filament after the drawing process. It is thus possible to reduce the surface roughness Ra of the ReW filament which has a desired diameter.

In addition, when the drawing process is repeated, drawing is started using the single-crystal diamond die having a pore diameter of 200 μm, when a weight ratio of an amount of oxide included in the tungsten wire having a mass of 50 MG is in a range from 0.2% to 0.5%. In this manner, saw wire 10 having the surface roughness Ra less than or equal to 0.15 μm is manufactured, as illustrated in (d) in FIG. 3.

It should be noted that FIG. 3 schematically illustrates each of the processes of the manufacturing method of saw wire 10. Each of the processes may be performed separately, or may be performed through an in-line process. For example, a plurality of wire drawing dies may be aligned in a descending order of pore diameters in a production line, and heating devices for conducting an annealing process, electrolytic polishing devices, or the like may be placed between the wire drawing dies.

### Advantageous Effects, Etc.

As described above, saw wire 10 according to the present embodiment includes a metal wire containing a tungsten alloy. The metal wire has the surface roughness Ra of at most 0.15 μm, an elastic modulus of at least 350 GPa and at most 450 GPa, a tensile strength of at least 3500 MPa, and diameter φ of at most 60 μm. In addition, for example, the tensile strength of the metal wire is at most 6000 MPa.

As described above, since the metal wire contains tungsten as a major component, the tensile strength of the metal wire increases and thereby tolerance against breakage is improved, as the metal wire is rendered thinner. With this configuration, since the metal wire has improved tolerance against breakage even after the thinning process, and therefore, it is possible to implement a metal wire which has the tensile strength equal to or higher than that of piano wire and the elastic modulus approximately twice as high as that of piano wire.

Since saw wire 10 according to the present embodiment is high in the tensile strength, it is possible to loop saw wire 10 over guide rollers 2 with a strong tension. Accordingly, it is possible to reduce the vibrations of saw wire 10 caused during the process of cutting ingot 20.

Moreover, since the surface roughness Ra of saw wire 10 is small, the stress applied to ingot 20 is uniformed. Accordingly, it is possible to cut ingot 20 smoothly. Thus, when the surface roughness Ra is small, the oscillation width of saw wire 10 can be reduced as well. Accordingly, it is possible to further reduce the kerf loss of ingot 20.

As described above, since saw wire 10 has small diameter φ and the surface roughness Ra, and is high in the tensile strength and elastic modulus, it is possible to reduce the amount of swarf produced when ingot 20 is sliced, i.e., the kerf loss of ingot 20. Accordingly, it is possible to increase the number of wafers cut out from a single ingot 20.

It addition, in saw wire 10 according to the present embodiment, for example, the tungsten alloy includes rhenium and tungsten, and a rhenium content of the tungsten alloy is at least 0.1 wt % and at most 10 wt % with respect to a total weight of rhenium and tungsten.

With this configuration, since the metal wire contains rhenium, it is possible to increase the tensile strength of the metal wire to be higher than the tensile strength of a pure tungsten wire. In addition, compared to the case where pure tungsten is used, unevenness such as a streak is less likely to be formed on the metal wire during the drawing process. Accordingly, it is possible to easily reduce the surface roughness Ra of the metal wire.

The ReW alloy wire has a feature that the tensile strength per an area of cross-section is increased by reducing the diameter size, and thus it is highly advantageous that saw wire 10 includes the ReW alloy wire.

In addition, cutting apparatus 1 according to the present embodiment includes saw wire 10, for example.

With this configuration, diameter φ of saw wire 10 is reduced, and thus it is possible to increase the number of wafers cut out from a single ingot 20. In addition, it is possible to reduce the amount of swarf produced when ingot 20 is sliced.

In addition, cutting apparatus 1 according to the present embodiment further includes, for example, tension releasing device 4 which releases tension exerted on saw wire 10.

With this configuration, it is possible to inhibit strong tension from being exerted on saw wire 10. Therefore, it is possible to inhibit breaking off or the like of saw wire 10.

(Variation)

Here, variation examples of the above-described embodiment will be described. The following description focuses on the difference from the above-described embodiment, and description for common points are omitted or

A saw wire according to the present variation includes a metal wire containing tungsten doped with potassium (K), instead of the ReW alloy. The saw wire according to the present variation is quite simply a metal wire.

The saw wire contains tungsten as a major component, and a predetermined proportion of rhenium. The potassium content of the saw wire is at least 0.005 wt % and at most 0.010 wt % with respect to a total weight of potassium and tungsten.

The metal wire containing tungsten doped with potassium (potassium-doped tungsten wire) has a tensile strength per an area of cross-section that increases with a decrease in diameter φ. Stated differently, with the use of such a potassium-doped tungsten wire, it is possible to implement saw wire having small diameter φ and a high tensile strength, and thereby to reduce the kerf loss of ingot 20.

The tensile strength, elastic modulus, diameter, the surface roughness Ra, etc. of the saw wire according to the present variation are respectively the same as those of saw wire 10 according to the embodiment.

As described above, in the saw wire according to the present variation, the metal wire containing tungsten is doped with potassium, and the potassium content of the metal wire is at least 0.005 wt % ai d at most 0.010 wt % with respect to a total weight of potassium and tungsten.

In this manner, since tungsten contains a subtle amount of potassium, crystal grain growth in the radial direction of the metal wire is inhibited. Accordingly, the saw wire according to the present variation is higher in strength at a high temperature than the case where pure tungsten is used.

The potassium-doped tungsten wire has a strength per an area of cross-section that increases with decreasing diameter φ. Accordingly, as with the case of the ReW alloy, use of the potassium-doped tungsten wire allows the surface of the metal wire to be resistant to scraping, and thus the surface can be easily rendered smooth. In other words, it is possible to easily manufacture a metal wire having the surface roughness Ra of at most 0.15 μm.

(Others)

Although the saw wire and the cutting apparatus according to the present disclosure have been described based on the above-described embodiment and the variations thereof, the present disclosure is not limited to the above-described embodiment.

For example, although rhenium tungsten (ReW) alloy is described as the tungsten alloy in the above-described embodiment, the tungsten alloy may be, for example, nickel-tungsten (NiW) alloy.

In addition, for example, although the case where saw wire 10 (i.e., metal wire) contains a tungsten alloy has been described in the above-described embodiment, the present disclosure is not limited to this example. Saw wire 10 may contain tungsten. In other words, the saw wire may contain pure tungsten. The degree of purity of tungsten may be 99.9% or higher, for example. However, the degree of purity of tungsten is not limited to this example.

In addition, for example, although the case where saw wire 10 is quite simply a metal wire has been described in the above-described embodiment, the present disclosure is not limited to this example. Saw wire 10 may include a metal wire and a plurality of abrasive particles included in the surface of the metal wire. More specifically, saw wire 10 may be a wire used in cutting apparatus 1 of the free abrasive particle type as described in the embodiment, or a wire used in a cutting apparatus of the fixed abrasive particle type. Examples of the abrasive particles include diamond, cubic boron nitride (CBN), etc.

In the case of the fixed abrasive particle type, since the surface roughness Ra of the metal wire is small, when the abrasive particles are fixed to the metal wire, stress applied to the abrasive particles during the process of slicing ingot 20 is easily and uniformly dispersed. Accordingly, it is possible to inhibit detachment of the abrasive particles from the metal wire, and thus a decrease in sharpness of saw wire 10 can be reduced. In addition, stress applied to ingot 20 via the abrasive particles can also be easily and uniformly dispersed. Thus, ingot 20 can be smoothly sliced and vibrations of saw wire 10 are reduced, making it possible to reduce the kerf loss of ingot 20.

Moreover, cutting apparatus 1 is not limited to a multi-wire saw, and may be, for example, a wire sawing apparatus that cuts out a wafer one by one by slicing ingot 20 using one wire saw 10. In addition, cutting apparatus 1 illustrated in FIG. 1 is merely an example, and thus need net include tension releasing device 4, for example.

It should be noted that the present disclosure also includes other forms in which various modifications apparent to those skilled in the art are applied to the embodiment or forms in which structural components and functions in the embodiment are arbitrarily combined within the scope of the present disclosure.

While the foregoing has described one or more embodiments and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

What is claimed is:

1. A saw wire, comprising:
a metal wire containing at least one of tungsten and a tungsten alloy, wherein
a surface roughness Ra of the metal wire is at most 0.15 μm,
a tensile strength of the metal wire is at least 3500 MPa, and
a diameter of the metal wire is at most 60 μm.

2. The saw wire according to claim 1, wherein
the tungsten alloy includes rhenium and tungsten, and
a rhenium content of the tungsten alloy is at least 0.1 wt % and at most 10 wt % with respect to a total weight of rhenium and tungsten.

3. The saw wire according to claim 2, wherein.
the diameter of the metal wire is at least 10 μm.

4. The saw wire according to claim 3, wherein
the diameter of the metal wire is uniform.

5. The saw wire according to claim 1, wherein
the metal wire containing tungsten is doped with potassium, and
a potassium content of the metal wire is at most 0.010 wt % with respect to a total weight of potassium and tungsten.

6. The saw wire according to claim 5, wherein
the potassium content of the metal wire is at least 0.005 wt % with respect to the total weight of potassium and tungsten.

7. The saw wire according to claim 5, wherein
the diameter of the metal wire is at least 10 μm.

8. The saw wire according to claim 7, wherein
the diameter of the metal wire is uniform.

9. The saw wire according to claim 1, wherein
the tensile strength of the metal wire is at most 6000 MPa.

10. The saw wire according to claim 1, wherein
the surface roughness Ra of the metal wire is greater than 0.05 μm,

11. The saw wire according claim 1, wherein
the diameter of the metal wire is at least 10 μm.

12. The saw wire according to claim 1, wherein
the diameter of the metal wire is uniform.

13. The saw wire according to claim 1, wherein
an elastic modulus of the metal wire is at least 350 GPa and at most 450 GPa.

14. A cutting apparatus, comprising the saw wire according to claim 1.

15. The cutting apparatus according to claim 14, further comprising:
a tension releasing device that releases tension exerted on the saw wire.

16. The saw wire according to claim 1, further comprising:
a plurality of abrasive particles provided around a surface of the metal wire.

17. The saw wire according to claim 16, wherein
the plurality of abrasive particles includes at least one of diamond and cubic boron nitride.

18. A method of slicing an ingot, the method comprising:
moving at least one saw wire relative to the ingot, each saw wire including a metal wire containing at least one of tungsten and a tungsten alloy, a surface roughness Ra of the metal wire being at most 0.15 μm, a tensile strength of the metal wire being at least 3500 MPa, and a diameter of the metal wire being at most 60 μm; and
dividing the ingot at least into partly-sliced portions by the at least one saw wire.

19. A method of manufacturing a saw wire, the method comprising:
forming a metal wire containing at least one of tungsten and a tungsten alloy, wherein
a surface roughness Ra of the metal wire is at most 0.15 μm,
a tensile strength of the metal wire is at least 3500 MPa, and
a diameter of the metal wire is at most 60 μm.

20. The method according to claim 19, wherein
the forming includes repeatedly performing a plurality of processes in sequence, and
the plurality of processes includes a wire drawing process, a polishing process, and a die exchange process.
